(19) United States
(12) Patent Application Publication
(10) Pub. No.: US 2021/0182808 A1
(43) Pub. Date: Jun. 17, 2021

(54) Method, System, and Computer Program Product for Distributing Data from Multiple Data Sources

(71) Applicant: Visa International Service Association, San Francisco, CA (US)

(72) Inventor: Gurpreet Singh Bhasin, Fremont, CA (US)

(21) Appl. No.: 16/712,003

(22) Filed: Dec. 12, 2019

(51) Int. Cl. G06Q 20/08; G06F 16/903; G06F 16/901

(52) U.S. Cl. CPC G06Q 20/08; G06F 16/9014; G06F 16/90348

(57) ABSTRACT

A method for distributing data from multiple data sources includes: receiving payment data associated with a plurality of users and a plurality of transactions; storing the payment data in a data storage device; receiving a query including a query parameter and a hash value derived from payment data for a user; searching the payment data stored in the data storage device based on the hash value and the query parameter to identify a data record from the payment data stored in the data storage device that matches the query, the data record received from a second payment system; generating a query response message based on the data record and the query parameter; transmitting the query response message to the first payment system; and associating a credit with the second payment system based on transmitting the query response message.

### BACKGROUND

### 1. Technical Field

The disclosure relates to distributing data and, in some non-limiting embodiments or aspects, to a method, system, and computer program product for distributing data from multiple data sources.

### 2. Technical Considerations

Fraud associated with electronic payment transactions is difficult to prevent at least in part because different entities involved in processing such payment transactions assess fraud risk separately and independently from one another. These entities assess fraud risk separately and independently because of the sensitivity of the payment data used to generate such assessments and the risks involved with sharing the sensitive data with other entities, both from a legal perspective and a business perspective. As such, existing systems for processing online payment transactions fail to optimally prevent fraud associated with electronic payment transactions at least because of data sharing limitations among the various entities involved in the processing flow.

### SUMMARY

Accordingly, and generally, provided is an improved method, system, and computer program product for distributing data from multiple data sources

According to some non-limiting embodiments or aspects, a method for distributing data from multiple data sources includes: receiving, from a plurality of payment systems, payment data associated with a plurality of users and a plurality of transactions; storing, with at least one processor, the payment data in at least one data storage device; receiving, from a first payment system, a query including at least one query parameter and at least one hash value derived from payment data for a user of the plurality of users; searching, with at least one processor, the payment data stored in the at least one data storage device based on the at least one hash value and the at least one query parameter to identify at least one data record from the payment data stored in the at least one data storage device that matches the query, where the at least one data record was received from a second payment system of the plurality of payment systems; generating, with at least one processor, a query response message based on the at least one data record and the at least one query parameter; transmitting, with at least one processor, the query response message to the first payment system; and associating, with at least one processor, at least one credit with the second payment system based on transmitting the query response message.

In some non-limiting embodiments or aspects, the payment data may include: (i) a plurality of account identifiers associated with the plurality of users and/or (ii) a plurality of hash values derived from the plurality of account identifiers. The query may include an account identifier, a hash value derived from the account identifier, and/or a hash algorithm identifier. The payment data may include a plurality of hash values derived from a single account identifier, each of the plurality of hash values derived from a different hashing algorithm. The at least one credit may be associated with the second payment system in response to identifying the at least one data record, generating the query response message, or transmitting the query response message. The query may include a payment system identifier associated with the first payment system, where the method may further include: determining, with at least one processor, whether the first payment system includes at least one credit; and in response to determining that the first payment system includes at least one credit, searching the payment data stored in the at least one data storage device based on the at least one hash value and the at least one query parameter to identify the at least one data record from the payment data stored in the at least one data storage device that matches the query.

According to some non-limiting embodiments or aspects, a system for distributing data from multiple data sources includes: at least one storage device; and at least one processor programmed or configured to: receive, from a plurality of payment systems, payment data associated with a plurality of users and a plurality of transactions; store the payment data in the at least one data storage device; receive a query including at least one query parameter and at least one hash value derived from payment data for a user of the plurality of users; search the payment data stored in the at least one data storage device based on the at least one hash value and the at least one query parameter to identify at least one data record from the payment data stored in the at least one data storage device that matches the query, where the at least one data record was received from a second payment system of the plurality of payment systems; generate a query response message based on the at least one data record and the at least one query parameter; transmit the query response message to the first payment system; and associate at least one credit with the second payment system based on transmitting the query response message.

In some non-limiting embodiments or aspects, the payment data may include: (i) a plurality of account identifiers associated with the plurality of users and/or (ii) a plurality of hash values derived from the plurality of account identifiers. The query may include an account identifier, a hash value derived from the account identifier, and/or a hash algorithm identifier. The payment data may include a plurality of hash values derived from a single account identifier, each of the plurality of hash values derived from a different hashing algorithm. The at least one credit may be associated with the second payment system in response to identifying the at least one data record, generating the query response message, or transmitting the query response message. The query may include a payment system identifier associated with the first payment system, where the at least one processor may be further programmed or configured to: determine whether the first payment system includes at least one credit; and in response to determining that the first payment system includes at least one credit, search the payment data stored in the at least one data storage device based on the at least one hash value and the at least one query parameter to identify the at least one data record from the payment data stored in the at least one data storage device that matches the query.

According to some non-limiting embodiments or aspects, a computer program product for distributing data from multiple data sources including at least one non-transitory computer-readable medium including one or more instructions that, when executed by at least one processor, cause the at least one processor to: receive, from a plurality of payment systems, payment data associated with a plurality of users and a plurality of transactions; store the payment data in at least one data storage device; receive a query including at least one query parameter and at least one hash value derived from payment data for a user of the plurality of users; search the payment data stored in the at least one data storage device based on the at least one hash value and the at least one query parameter to identify at least one data record from the payment data stored in the at least one data storage device that matches the query, where the at least one data record was received from a second payment system of the plurality of payment systems; generate a query response message based on the at least one data record and the at least one query parameter; transmit the query response message to the first payment system; and associate at least one credit with the second payment system based on transmitting the query response message.

In some non-limiting embodiments or aspects, the payment data may include: (i) a plurality of account identifiers associated with the plurality of users and/or (ii) a plurality of hash values derived from the plurality of account identifiers. The query may include an account identifier, a hash value derived from the account identifier, and/or a hash algorithm identifier. The payment data may include a plurality of hash values derived from a single account identifier, each of the plurality of hash values derived from a different hashing algorithm. The at least one credit may be associated with the second payment system in response to identifying the at least one data record, generating the query response message, or transmitting the query response message. The query may include a payment system identifier associated with the first payment system, where the one or more instructions, when executed by at least one processor, may cause the at least one processor to: determine whether the first payment system includes at least one credit; and in response to determining that the first payment system includes at least one credit, search the payment data stored in the at least one data storage device based on the at least one hash value and the at least one query parameter to identify the at least one data record from the payment data stored in the at least one data storage device that matches the query.

According to some non-limiting embodiments or aspects, a method for distributing data from multiple data sources includes: receiving, from a plurality of merchant systems, a plurality of transaction request messages including payment data associated with a plurality of users and a plurality of transactions; for each transaction request message, hashing, with at least one processor, at least a portion of the payment data associated with the transaction request message with a first hash algorithm to generate a first hashed value and hashing, with at least one processor, the at least a portion of the payment data associated with the transaction request message with a second hash algorithm to generate a second hashed value; communicating, from a first payment system of a plurality of payment systems, the first hashed value and the second hashed value to a central server to cause the central server to store the first hashed value and the second hashed value in association with a user of the plurality of users associated with the transaction request message in at least one data storage device; communicating, from the first payment system and to the central server, a query including at least one query parameter and at least one hash value derived from payment data for a user of the plurality of users; and receiving, by the first payment system and from the central server, a query response message based on payment data stored in the at least one data storage device that matches the query, where the payment data stored in the at least one data storage device that matches the query was received by the central server from a second payment system of the plurality of payment systems.

In some non-limiting embodiments or aspects, the query may cause the central server to: search the payment data stored in the at least one data storage device based on the at least one hash value and the at least one query parameter to identify at least one data record from the payment data stored in the at least one data storage device that matches the query, where the at least one data record was received from a second payment system of the plurality of payment systems; generate the query response message based on the at least one data record and the at least one query parameter; and transmit the query response message to the first payment system; and associate at least one credit with the second payment system based on transmitting the query response message. The payment data may include: (i) a plurality of account identifiers associated with the plurality of users and/or (ii) a plurality of hash values derived from the plurality of account identifiers. The query may include an account identifier, a hash value derived from the account identifier, and/or a hash algorithm identifier. The query may include a payment system identifier associated with the first payment system, where the query may cause the central server to: determine whether the first payment system includes at least one credit; and in response to determining that the first payment system includes at least one credit, search the payment data stored in the at least one data storage device based on the at least one hash value and the at least one query parameter to identify the at least one data record from the payment data stored in the at least one data storage device that matches the query. The method may include receiving, by the first payment system and from the central server, at least one credit in response to communicating the first hashed value and the second hashed value to the central server.

According to some non-limiting embodiments or aspects, a system for distributing data from multiple data sources including at least one processor of a first payment system of a plurality of payment systems programmed or configured to: receive, from a plurality of merchant systems, a plurality of transaction request messages including payment data associated with a plurality of users and a plurality of transactions; for each transaction request message, hash at least a portion of the payment data associated with the transaction request message with a first hash algorithm to generate a first hashed value and hash the at least a portion of the payment data associated with the transaction request message with a second hash algorithm to generate a second hashed value; communicate the first hashed value and the second hashed value to a central server to cause the central server to store the first hashed value and the second hashed value in association with a user of the plurality of users associated with the transaction request message in at least one data storage device; communicate, to the central server, a query including at least one query parameter and at least one hash value derived from payment data for a user of the plurality of users; and receive, from the central server, a query response message based on payment data stored in the at least one data storage device that matches the query, where the payment data stored in the at least one data storage device that matches the query was received by the central server from a second payment system of the plurality of payment systems.

In some non-limiting embodiments or aspects, the query may cause the central server to: search the payment data stored in the at least one data storage device based on the at least one hash value and the at least one query parameter to identify at least one data record from the payment data stored in the at least one data storage device that matches the query, where the at least one data record was received from a second payment system of the plurality of payment systems; generate the query response message based on the at least one data record and the at least one query parameter; and transmit the query response message to the first payment system; and associate at least one credit with the second payment system based on transmitting the query response message. The payment data may include: (i) a plurality of account identifiers associated with the plurality of users and/or (ii) a plurality of hash values derived from the plurality of account identifiers. The query may include an account identifier, a hash value derived from the account identifier, and/or a hash algorithm identifier. The query may include a payment system identifier associated with the first payment system, where the query may cause the central server to: determine whether the first payment system includes at least one credit; and in response to determining that the first payment system includes at least one credit, search the payment data stored in the at least one data storage device based on the at least one hash value and the at least one query parameter to identify the at least one data record from the payment data stored in the at least one data storage device that matches the query. The at least one processor may be further programmed or configured to: receive, from the central server, at least one credit in response to communicating the first hashed value and the second hashed value to the central server.

According to some non-limiting embodiments or aspects, a computer program product for distributing data from multiple data sources includes at least one non-transitory computer-readable medium including one or more instructions that, when executed by at least one processor, cause the at least one processor to: receive, from a plurality of merchant systems, a plurality of transaction request messages including payment data associated with a plurality of users and a plurality of transactions; for each transaction request message, hash at least a portion of the payment data associated with the transaction request message with a first hash algorithm to generate a first hashed value and hash the at least a portion of the payment data associated with the transaction request message with a second hash algorithm to generate a second hashed value; communicate the first hashed value and the second hashed value to a central server to cause the central server to store the first hashed value and the second hashed value in association with a user of the plurality of users associated with the transaction request message in at least one data storage device; communicate, to the central server, a query including at least one query parameter and at least one hash value derived from payment data for a user of the plurality of users; and receive, from the central server, a query response message based on payment data stored in the at least one data storage device that matches the query, where the payment data stored in the at least one data storage device that matches the query was received by the central server from a second payment system of the plurality of payment systems.

In some non-limiting embodiments or aspects, the query may cause the central server to: search the payment data stored in the at least one data storage device based on the at least one hash value and the at least one query parameter to identify at least one data record from the payment data stored in the at least one data storage device that matches the query, where the at least one data record was received from a second payment system of the plurality of payment systems; generate the query response message based on the at least one data record and the at least one query parameter; and transmit the query response message to the first payment system; and associate at least one credit with the second payment system based on transmitting the query response message. The payment data may include: (i) a plurality of account identifiers associated with the plurality of users and/or (ii) a plurality of hash values derived from the plurality of account identifiers. The query may include an account identifier, a hash value derived from the account identifier, and/or a hash algorithm identifier. The query may include a payment system identifier associated with the first payment system, where the query causes the central server to: determine whether the first payment system includes at least one credit; and in response to determining that the first payment system includes at least one credit, search the payment data stored in the at least one data storage device based on the at least one hash value and the at least one query parameter to identify the at least one data record from the payment data stored in the at least one data storage device that matches the query. The one or more instructions, when executed by at least one processor, may cause the at least one processor to: receive, from the central server, at least one credit in response to communicating the first hashed value and the second hashed value to the central server.

Further non-limiting embodiments or aspects are set forth in the following numbered clauses:

Clause 1: A method for distributing data from multiple data sources, comprising: receiving, from a plurality of payment systems, payment data associated with a plurality of users and a plurality of transactions; storing, with at least one processor, the payment data in at least one data storage device; receiving, from a first payment system, a query comprising at least one query parameter and at least one hash value derived from payment data for a user of the plurality of users; searching, with at least one processor, the payment data stored in the at least one data storage device based on the at least one hash value and the at least one query parameter to identify at least one data record from the payment data stored in the at least one data storage device that matches the query, wherein the at least one data record was received from a second payment system of the plurality of payment systems; generating, with at least one processor, a query response message based on the at least one data record and the at least one query parameter; transmitting, with at least one processor, the query response message to the first payment system; and associating, with at least one processor, at least one credit with the second payment system based on transmitting the query response message.

Clause 2: The method of clause 1, wherein the payment data comprises: (i) a plurality of account identifiers associated with the plurality of users and/or (ii) a plurality of hash values derived from the plurality of account identifiers.

Clause 3: The method of clause 1 or 2, wherein the query comprises an account identifier, a hash value derived from the account identifier, and/or a hash algorithm identifier.

Clause 4: The method of any of clauses 1-3, wherein the payment data comprises a plurality of hash values derived from a single account identifier, each of the plurality of hash values derived from a different hashing algorithm.

Clause 5: The method of any of clauses 1-4, wherein the at least one credit is associated with the second payment system in response to identifying the at least one data record, generating the query response message, or transmitting the query response message.

Clause 6: The method of any of clauses 1-5, wherein the query comprises a payment system identifier associated with the first payment system, wherein the method further comprises: determining, with at least one processor, whether the first payment system comprises at least one credit; and in response to determining that the first payment system comprises at least one credit, searching the payment data stored in the at least one data storage device based on the at least one hash value and the at least one query parameter to identify the at least one data record from the payment data stored in the at least one data storage device that matches the query.

Clause 7: A system for distributing data from multiple data sources, comprising: at least one storage device; and at least one processor programmed or configured to: receive, from a plurality of payment systems, payment data associated with a plurality of users and a plurality of transactions; store the payment data in the at least one data storage device; receive a query comprising at least one query parameter and at least one hash value derived from payment data for a user of the plurality of users; search the payment data stored in the at least one data storage device based on the at least one hash value and the at least one query parameter to identify at least one data record from the payment data stored in the at least one data storage device that matches the query, wherein the at least one data record was received from a second payment system of the plurality of payment systems; generate a query response message based on the at least one data record and the at least one query parameter; transmit the query response message to the first payment system; and associate at least one credit with the second payment system based on transmitting the query response message.

Clause 8: The system of clause 7, wherein the payment data comprises: (i) a plurality of account identifiers associated with the plurality of users and/or (ii) a plurality of hash values derived from the plurality of account identifiers.

Clause 9: The system of clause 7 or 8, wherein the query comprises an account identifier, a hash value derived from the account identifier, and/or a hash algorithm identifier.

Clause 10: The system of any of clauses 7-9, wherein the payment data comprises a plurality of hash values derived from a single account identifier, each of the plurality of hash values derived from a different hashing algorithm.

Clause 11: The system of any of clauses 7-10, wherein the at least one credit is associated with the second payment system in response to identifying the at least one data record, generating the query response message, or transmitting the query response message.

Clause 12: The system of any of clauses 7-11, wherein the query comprises a payment system identifier associated with the first payment system, wherein the at least one processor is further programmed or configured to: determine whether the first payment system comprises at least one credit; and in response to determining that the first payment system comprises at least one credit, search the payment data stored in the at least one data storage device based on the at least one hash value and the at least one query parameter to identify the at least one data record from the payment data stored in the at least one data storage device that matches the query.

Clause 13: A computer program product for distributing data from multiple data sources, the computer program product comprising at least one non-transitory computer-readable medium including one or more instructions that, when executed by at least one processor, cause the at least one processor to: receive, from a plurality of payment systems, payment data associated with a plurality of users and a plurality of transactions; store the payment data in at least one data storage device; receive a query comprising at least one query parameter and at least one hash value derived from payment data for a user of the plurality of users; search the payment data stored in the at least one data storage device based on the at least one hash value and the at least one query parameter to identify at least one data record from the payment data stored in the at least one data storage device that matches the query, wherein the at least one data record was received from a second payment system of the plurality of payment systems; generate a query response message based on the at least one data record and the at least one query parameter; transmit the query response message to the first payment system; and associate at least one credit with the second payment system based on transmitting the query response message.

Clause 14: The computer program product of clause 13, wherein the payment data comprises: (i) a plurality of account identifiers associated with the plurality of users and/or (ii) a plurality of hash values derived from the plurality of account identifiers.

Clause 15: The computer program product of clause 13 or 14, wherein the query comprises an account identifier, a hash value derived from the account identifier, and/or a hash algorithm identifier.

Clause 16: The computer program product of any of clauses 13-15, wherein the payment data comprises a plurality of hash values derived from a single account identifier, each of the plurality of hash values derived from a different hashing algorithm.

Clause 17: The computer program product of any of clauses 13-16, wherein the at least one credit is associated with the second payment system in response to identifying the at least one data record, generating the query response message, or transmitting the query response message.

Clause 18: The computer program product of any of clauses 13-17, wherein the query comprises a payment system identifier associated with the first payment system, wherein the one or more instructions, when executed by at least one processor, cause the at least one processor to: determine whether the first payment system comprises at least one credit; and in response to determining that the first payment system comprises at least one credit, search the payment data stored in the at least one data storage device based on the at least one hash value and the at least one query parameter to identify the at least one data record from the payment data stored in the at least one data storage device that matches the query.

Clause 19: A method for distributing data from multiple data sources, comprising: receiving, from a plurality of merchant systems, a plurality of transaction request messages comprising payment data associated with a plurality of users and a plurality of transactions; for each transaction request message, hashing, with at least one processor, at least a portion of the payment data associated with the transaction request message with a first hash algorithm to generate a first hashed value and hashing, with at least one processor, the at least a portion of the payment data associated with the transaction request message with a second hash algorithm to generate a second hashed value; communicating, from a first payment system of a plurality of payment systems, the first hashed value and the second hashed value to a central server to cause the central server to store the first hashed value and the second hashed value in association with a user of the plurality of users associated with the transaction request message in at least one data storage device; communicating, from the first payment system and to the central server, a query comprising at least one query parameter and at least one hash value derived from payment data for a user of the plurality of users; and receiving, by the first payment system and from the central server, a query response message based on payment data stored in the at least one data storage device that matches the query, wherein the payment data stored in the at least one data storage device that matches the query was received by the central server from a second payment system of the plurality of payment systems.

Clause 20: The method of clause 19, wherein the query causes the central server to: search the payment data stored in the at least one data storage device based on the at least one hash value and the at least one query parameter to identify at least one data record from the payment data stored in the at least one data storage device that matches the query, wherein the at least one data record was received from a second payment system of the plurality of payment systems; generate the query response message based on the at least one data record and the at least one query parameter; and transmit the query response message to the first payment system; and associate at least one credit with the second payment system based on transmitting the query response message.

Clause 21: The method of clause 19 or 20, wherein the payment data comprises: (i) a plurality of account identifiers associated with the plurality of users and/or (ii) a plurality of hash values derived from the plurality of account identifiers.

Clause 22: The method of any of clauses 19-21, wherein the query comprises an account identifier, a hash value derived from the account identifier, and/or a hash algorithm identifier.

Clause 23: The method of any of clauses 19-22, wherein the query comprises a payment system identifier associated with the first payment system, wherein the query causes the central server to: determine whether the first payment system comprises at least one credit; and in response to determining that the first payment system comprises at least one credit, search the payment data stored in the at least one data storage device based on the at least one hash value and the at least one query parameter to identify the at least one data record from the payment data stored in the at least one data storage device that matches the query.

Clause 24: The method of any of clauses 19-23, further comprising: receiving, by the first payment system and from the central server, at least one credit in response to communicating the first hashed value and the second hashed value to the central server.

Clause 25: A system for distributing data from multiple data sources, comprising at least one processor of a first payment system of a plurality of payment systems programmed or configured to: receive, from a plurality of merchant systems, a plurality of transaction request messages comprising payment data associated with a plurality of users and a plurality of transactions; for each transaction request message, hash at least a portion of the payment data associated with the transaction request message with a first hash algorithm to generate a first hashed value and hash the at least a portion of the payment data associated with the transaction request message with a second hash algorithm to generate a second hashed value; communicate the first hashed value and the second hashed value to a central server to cause the central server to store the first hashed value and the second hashed value in association with a user of the plurality of users associated with the transaction request message in at least one data storage device; communicate, to the central server, a query comprising at least one query parameter and at least one hash value derived from payment data for a user of the plurality of users; and receive, from the central server, a query response message based on payment data stored in the at least one data storage device that matches the query, wherein the payment data stored in the at least one data storage device that matches the query was received by the central server from a second payment system of the plurality of payment systems.

Clause 26: The system of clause 25, wherein the query causes the central server to: search the payment data stored in the at least one data storage device based on the at least one hash value and the at least one query parameter to identify at least one data record from the payment data stored in the at least one data storage device that matches the query, wherein the at least one data record was received from a second payment system of the plurality of payment systems; generate the query response message based on the at least one data record and the at least one query parameter; and transmit the query response message to the first payment system; and associate at least one credit with the second payment system based on transmitting the query response message.

Clause 27: The system of clause 25 or 26, wherein the payment data comprises: (i) a plurality of account identifiers associated with the plurality of users and/or (ii) a plurality of hash values derived from the plurality of account identifiers.

Clause 28: The system of any of clauses 25-27, wherein the query comprises an account identifier, a hash value derived from the account identifier, and/or a hash algorithm identifier.

Clause 29: The system of any of clauses 25-28, wherein the query comprises a payment system identifier associated with the first payment system, wherein the query causes the central server to: determine whether the first payment system comprises at least one credit; and in response to determining that the first payment system comprises at least one credit, search the payment data stored in the at least one data storage device based on the at least one hash value and the at least one query parameter to identify the at least one data record from the payment data stored in the at least one data storage device that matches the query.

Clause 30: The system of any of clauses 25-29, wherein the at least one processor is further programmed or configured to: receive, from the central server, at least one credit in response to communicating the first hashed value and the second hashed value to the central server.

Clause 31: A computer program product for distributing data from multiple data sources, the computer program product comprising at least one non-transitory computer-readable medium including one or more instructions that, when executed by at least one processor, cause the at least one processor to: receive, from a plurality of merchant systems, a plurality of transaction request messages comprising payment data associated with a plurality of users and a plurality of transactions; for each transaction request message, hash at least a portion of the payment data associated with the transaction request message with a first hash algorithm to generate a first hashed value and hash the at least a portion of the payment data associated with the transaction request message with a second hash algorithm to generate a second hashed value; communicate the first hashed value and the second hashed value to a central server to cause the central server to store the first hashed value and the second hashed value in association with a user of the plurality of users associated with the transaction request message in at least one data storage device; communicate, to the central server, a query comprising at least one query parameter and at least one hash value derived from payment data for a user of the plurality of users; and receive, from the central server, a query response message based on payment data stored in the at least one data storage device that matches the query, wherein the payment data stored in the at least one data storage device that matches the query was received by the central server from a second payment system of the plurality of payment systems.

Clause 32: The computer program product of clause 31, wherein the query causes the central server to: search the payment data stored in the at least one data storage device based on the at least one hash value and the at least one query parameter to identify at least one data record from the payment data stored in the at least one data storage device that matches the query, wherein the at least one data record was received from a second payment system of the plurality of payment systems; generate the query response message based on the at least one data record and the at least one query parameter; and transmit the query response message to the first payment system; and associate at least one credit with the second payment system based on transmitting the query response message.

Clause 33: The computer program product of clause 31 or 32, wherein the payment data comprises: (i) a plurality of account identifiers associated with the plurality of users and/or (ii) a plurality of hash values derived from the plurality of account identifiers.

Clause 34: The computer program product of any of clauses 31-33, wherein the query comprises an account identifier, a hash value derived from the account identifier, and/or a hash algorithm identifier.

Clause 35: The computer program product of any of clauses 31-34, wherein the query comprises a payment system identifier associated with the first payment system, wherein the query causes the central server to: determine whether the first payment system comprises at least one credit; and in response to determining that the first payment system comprises at least one credit, search the payment data stored in the at least one data storage device based on the at least one hash value and the at least one query parameter to identify the at least one data record from the payment data stored in the at least one data storage device that matches the query.

Clause 36: The computer program product of any of clauses 31-35, wherein the one or more instructions, when executed by at least one processor, cause the at least one processor to: receive, from the central server, at least one credit in response to communicating the first hashed value and the second hashed value to the central server.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure.

### BRIEF DESCRIPTION OF THE DRAWINGS

Additional advantages and details of the disclosure are explained in greater detail below with reference to the non-limiting exemplary embodiments that are illustrated in the accompanying schematic figures, in which:

FIG. 1 shows a system for distributing data from multiple data sources according to some non-limiting embodiments or aspects;

FIG. 2 shows a system for distributing data from multiple data sources according to some non-limiting embodiments or aspects;

FIG. 3 shows a data structure of a shared data message according to some non-limiting embodiments or aspects;

FIG. 4 shows a first, second, and nth hashed value associated with an account identifier according to some non-limiting embodiments or aspects;

FIG. 5 shows a data structure of a query according to some non-limiting embodiments or aspects;

FIG. 6 shows a data structure of a query response message according to some non-limiting embodiments or aspects;

FIG. 7 shows a step diagram of a method for distributing data from multiple data sources according to some non-limiting embodiments or aspects;

FIG. 8 shows a step diagram of a method for distributing data from multiple data sources according to some non-limiting embodiments or aspects; and

FIG. 9 shows a process flow diagram of a method for distributing data from multiple data sources according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the term “account identifier” may include one or more types of identifiers associated with a user account (e.g., a PAN, a primary account number, a card number, a payment card number, a token, and/or the like). In some non-limiting embodiments, an issuer institution may provide an account identifier (e.g., a PAN, a token, and/or the like) to a user that uniquely identifies one or more accounts associated with that user. The account identifier may be embodied on a payment device (e.g., a portable payment instrument, a payment card, a credit card, a debit card, and/or the like) and/or may be electronic information communicated to the user that the user may use for electronic payments. In some non-limiting embodiments, the account identifier may be an original account identifier, where the original account identifier was provided to a user at the creation of the account associated with the account identifier. In some non-limiting embodiments, the account identifier may be an account identifier (e.g., a supplemental account identifier) that is provided to a user after the original account identifier was provided to the user. For example, if the original account identifier is forgotten, stolen, and/or the like, a supplemental account identifier may be provided to the user. In some non-limiting embodiments, an account identifier may be directly or indirectly associated with an issuer institution such that an account identifier may be a token that maps to a PAN or other type of identifier. Account identifiers may be alphanumeric, any combination of characters and/or symbols, and/or the like. An issuer institution may be associated with a bank identification number (BIN) that uniquely identifies the issuer institution.

As used herein, the term “acquirer” may refer to an entity licensed by the transaction service provider and approved by the transaction service provider to originate transactions (e.g., payment transactions) using a payment device associated with the transaction service provider. As used herein, the term “acquirer system” may also refer to one or more computer systems, computer devices, and/or the like operated by or on behalf of an acquirer. The transactions the acquirer may originate may include payment transactions (e.g., purchases, original credit transactions (OCTs), account funding transactions (AFTs), and/or the like). In some non-limiting embodiments, the acquirer may be authorized by the transaction service provider to assign merchant or service providers to originate transactions using a payment device of the transaction service provider. The acquirer may contract with payment facilitators to enable the payment facilitators to sponsor merchants. The acquirer may monitor compliance of the payment facilitators in accordance with regulations of the transaction service provider. The acquirer may conduct due diligence of the payment facilitators and ensure proper due diligence occurs before signing a sponsored merchant. The acquirer may be liable for all transaction service provider programs that the acquirer operates or sponsors. The acquirer may be responsible for the acts of the acquirer's payment facilitators, merchants that are sponsored by the acquirer's payment facilitators, and/or the like. In some non-limiting embodiments, an acquirer may be a financial institution, such as a bank.

As used herein, the terms “communication” and “communicate” may refer to the reception, receipt, transmission, transfer, provision, and/or the like, of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices that are configured to directly or indirectly communicate with or over one or more networks. The computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. The computing device may be a non-mobile device, such as a desktop computer. Furthermore, the term “computer” may refer to any computing device that includes the necessary components to receive, process, and output data, and normally includes a display, a processor, a memory, an input device, and a network interface. An “application” or “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, etc.).

As used herein, the term “issuer institution” may refer to one or more entities, such as a bank, that provide accounts to users for conducting transactions (e.g., payment transactions), such as initiating credit and/or debit payments. For example, an issuer institution may provide an account identifier, such as a PAN, to a user that uniquely identifies one or more accounts associated with that user. The account identifier may be embodied on a payment device, such as a physical financial instrument, e.g., a payment card, and/or may be electronic and used for electronic payments. The term “issuer system” refers to one or more computer systems, computing devices, software applications, and/or the like operated by or on behalf of an issuer institution, such as a server computer executing one or more software applications. For example, an issuer system may include one or more authorization servers for authorizing a transaction, one or more authentication servers for authenticating a transaction, and/or one or more databases of account data. An issuer system may include a separate or integrated issuer authentication system, such as an Access Control Server (ACS), for authenticating online transactions. An issuer institution may be associated with a bank identification number (BIN) or other unique identifier that uniquely identifies it among other issuer institutions.

As used herein, the term “merchant” may refer to an individual or entity that provides goods and/or services, or access to goods and/or services, to users (e.g., users) based on a transaction (e.g., a payment transaction). The term “merchant system” may refer to one or more computer systems, computing devices, and/or software applications operated by or on behalf of a merchant, such as a server computer executing one or more software applications. A “point-of-sale (POS) system,” as used herein, may refer to one or more computers and/or peripheral devices used by a merchant to engage in payment transactions with users, including one or more card readers, near-field communication (NFC) receivers, RFID receivers, and/or other contactless transceivers or receivers, contact-based receivers, payment terminals, computers, servers, input devices, and/or other like devices that can be used to initiate a payment transaction. A POS system may be part of a merchant system. A merchant system may also include a merchant plug-in for facilitating online, Internet-based transactions through a merchant webpage or software application. A merchant plug-in may include software that runs on a merchant server or is hosted by a third-party for facilitating such online transactions.

As used herein, the term “payment device” may refer to a portable financial device, an electronic payment device, a payment card (e.g., a credit or debit card), a gift card, a smartcard, smart media, a payroll card, a healthcare card, a wrist band, a machine-readable medium containing account information, a keychain device or fob, an RFID transponder, a retailer discount or loyalty card, a cellular phone, an electronic wallet mobile application, a personal digital assistant (PDA), a pager, a security card, a computer, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of payment devices managed by a transaction service provider. As used herein, the term “payment gateway system” may refer to one or more computer systems, computer devices, servers, groups of servers, and/or the like, operated by or on behalf of a payment gateway and/or to a payment gateway itself. The term “payment gateway mobile application” may refer to one or more electronic devices and/or one or more software applications configured to provide payment services for transactions (e.g., payment transactions, electronic payment transactions, and/or the like).

As used herein, the term “server” and/or “processor” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.” Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments, may be operated by or on behalf of a transaction service provider.

Non-limiting embodiments or aspects of the present disclosure are directed to a method, system, and computer program product for distributing data from multiple data sources. Non-limiting embodiments or aspects enable systems involved in processing electronic payment transactions to generate risk assessments based on payment data collected by other systems also involved in processing electronic payment transactions. As such, the risk assessments generated based on the present disclosure are more comprehensive and, as a result, more effective than those generated by existing systems. Non-limiting embodiments or aspects provide systems running risk assessments with the sensitive payment data in order to run the more comprehensive risk assessment without exposing the private contents of the sensitive data to the system running the risk assessment. This is because the payment data is irreversibly hashed such that a system obtaining the payment data cannot determine the original payment data from which the hashed payment data is derived. Non-limiting embodiments or aspects provide a private data system (also referred to herein as a central server) which enables the various entities involved in processing electronic payment transactions to store their hashed payment data, such that the hashed data is available to other payment systems for use in generating risk analysis associated with a user or electronic payment transaction (without exposing the actual payment data to those other entities). The various systems may both share collected, hashed payment data with the private data system when payment data is collected thereby and query the private data system when generating a risk analysis. The various systems may receive credits based on sharing collected, hashed payment data, which credits may be redeemed during the querying of the private data system, resulting in an efficient, comprehensive, and private data sharing environment.

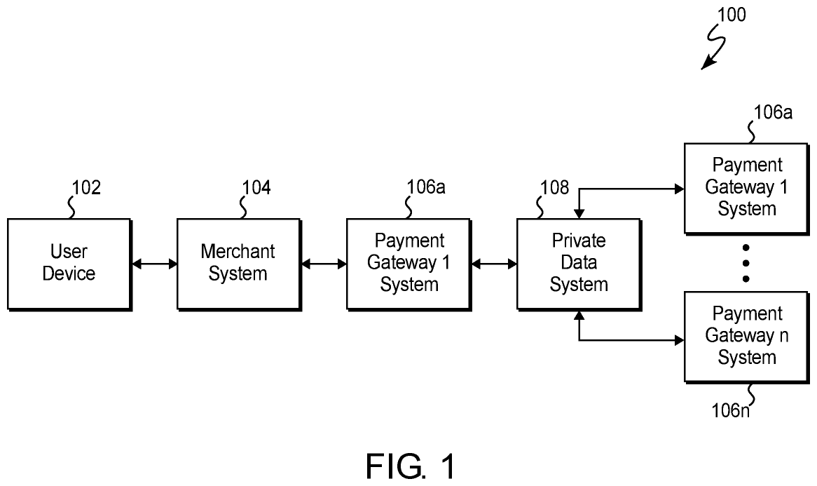

Referring to FIG. 1, a system 100 is shown for distributing data from multiple data sources according to some non-limiting embodiments or aspects. The system 100 may include a user device 102 associated with a user (e.g., a consumer) initiating an electronic payment transaction with a merchant system 104 operated by or on behalf of a merchant. The electronic payment transaction may be an online payment transaction initiated over the Internet. The user device 102 may be a payment device. The user device 102 may be a computing device, such as a computing device in which the user may initiate an electronic payment transaction with the merchant system 104 using a browser or smartphone application on the computing device using a payment device. The user device 102 may initiate the transaction with the merchant system 104 by communicating payment data to the merchant system 104. The payment data may include data identifying the user and/or the user's payment device, such as a user name, user contact information (e.g., shipping and/or billing address, phone number, email address), a user identifier (e.g., social security number, driver's license number, and the like), payment device account identifier, payment device expiration date, payment device card verification value (cvv), payment device PIN number, IP address of browser or user device 102, location data (e.g., location where a user initiated the payment transaction, such as based on GPS location data) and the like. The payment data may include any data used to process electronic payment transactions, such as data elements specified in ISO 8583. The payment data may include data used during processing of the electronic payment transaction to authorize and/or authenticate the payment.

In response to the user device 102 initiating the electronic payment transaction, the merchant system 104 may generate a transaction request message and communicate the transaction request message to a first payment gateway system 106a operated by or on behalf of the payment gateway associated with the user's payment device. The transaction request message may include payment data received from the user device 102. The transaction request message may include payment data generated or retrieved by the merchant system 104, such as data specified in ISO 8583. The payment data may include a merchant type, a merchant category code, a merchant identifier, transaction amount, transaction date/time, purchase details (e.g., UPC code, units of goods, price of goods, and the like), risk data (e.g., risk scores associated with the user), and the like. The transaction request message may cause the electronic payment transaction to be processed over an electronic payment processing network, the processing including authorization, clearing, and settlement of the electronic payment transaction. The electronic payment processing network may include at least one of the merchant system 104, a payment gateway system 106a, an acquirer system operated by or on behalf of an acquirer, a transaction processing system operated by or on behalf of a transaction service provider, an issuer system operated by or on behalf of an issuer, an authentication system operated by or on behalf of an authentication entity, and the like.

With continued reference to FIG. 1, the first payment gateway system 106a may receive a plurality of transaction request messages from a plurality of merchant systems (of various merchants) associated with a plurality of users initiating a plurality of electronic payment transactions with the various merchant systems. The first payment gateway system 106a may generate additional payment data from the transaction request message, such as payment data for further processing of the electronic payment transaction according to ISO 8583. For each received transaction request message, the electronic payment processing network may process the electronic payment transaction to completion.

In addition, during and/or after the electronic payment processing message is processed by the electronic payment processing network, the first payment gateway system 106a may initiate a sharing protocol, which may include communicating a shared data message including payment data associated with the electronic payment transaction to a private data system 108. The private data system 108 may be operated by or on behalf of a payment gateway, an acquirer, a transaction service provider, an issuer, or other like entity. Further discussion of the sharing protocol will be included hereinafter.

With continued reference to FIG. 1, the private data system 108 may be in communication with a plurality of payment gateway systems 106a, 106n. The plurality of gateway systems 106a, 106n may initiate a query protocol, which may include communicating a query to the private data system 108, to cause the private data system 108 to generate and return a query response message. Further discussion of the query protocol will be included hereinafter.

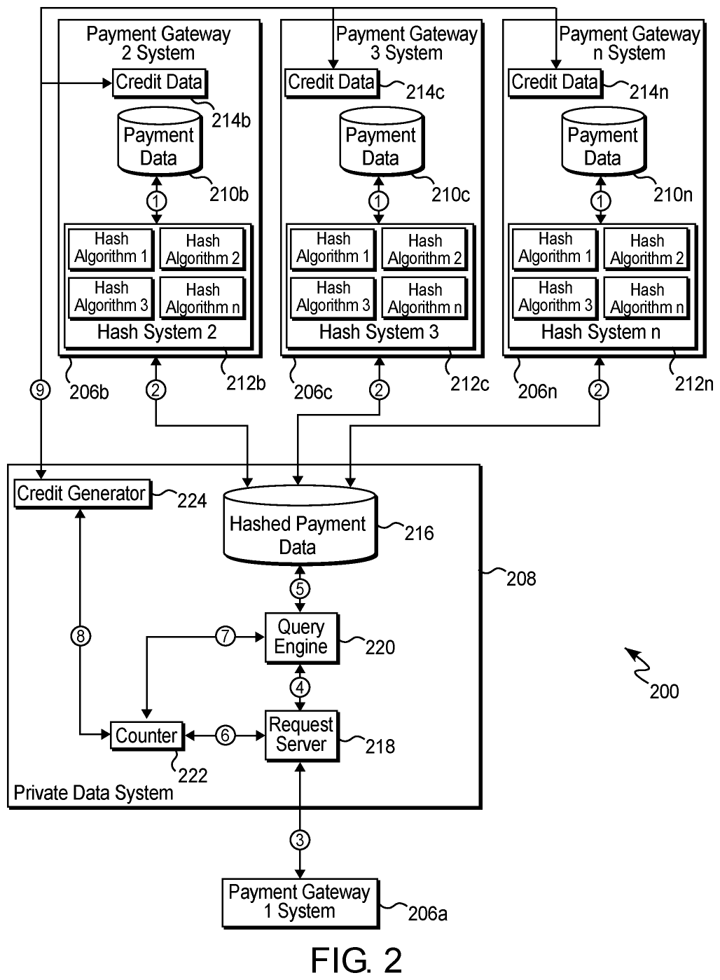

Referring to FIG. 2, a system 200 is shown for distributing data from multiple data sources according to some non-limiting embodiments or aspects. The system 200 may include a plurality of payment gateway systems 206a-206n in communication with the private data system 208. The payment gateway systems 206a-206n may be associated with payment gateways. However, it will be appreciated that in some non-limiting embodiments or aspects, the payment gateway systems may be replaced by payment systems associated with other entities involved in the electronic payment process, such as acquirer systems, transaction service provider systems, and/or issuer systems. It will be appreciated that element numbers ending in the same two digits correspond to other element number having the same final two digits and may include the same features or characteristics, except where indicated to the contrary.

The system 200 may include a first payment gateway system 206a, which, in the illustrated embodiment executes the query protocol. The system 200 may include a second, third, and nth payment gateway system 206b, 206c, 206n, which, in the illustrated embodiment execute the sharing protocol.

With continued reference to FIG. 2, according to some non-limiting embodiments or aspects, the payment gateway systems 206b-206n may each include a payment data database 210b-210n storing payment data received by the payment gateway systems 206a-206n from various merchant systems. The payment data database 210b-210n may include unhashed payment data and/or hashed payment data. As used herein, “hashed” data includes data that has been converted from its original form having an original value to a hashed form having a value different from the original value. Data may be hashed by applying a hashing algorithm to the original value to generate the hashed data. As such, hashed data may be derived from the original data by converting the original data to hashed data using at least one hash algorithm. The hashed data may be reversible so as to be capable of being reversed to the original value if the hash algorithm is known. The hashed data may be irreversible so as to be incapable of being reversed to the original value even if the hash algorithm is known.

With continued reference to FIG. 2, according to some non-limiting embodiments or aspects, the payment gateway systems 206b-206n may each include a hash system 212b-212n storing a plurality of hash algorithms (e.g., hash algorithm 1, hash 2, hash algorithm 3, hash algorithm n). The hash algorithms stored in the hash system 212b-212n may be used to derive (generate) the hashed payment data (also considered payment data) from the payment data stored in the payment data database 210b-210n. The hash algorithms included in the hash algorithm system 212b-212n may include any hash algorithm suitable for generating the hashed payment data from the payment data stored in the payment data database 210b-210n. Non-limiting examples of hash algorithms that may be used include SHA-1, SHA-3, SHA-256, SHA-512, Blake2, and the like.

With continued reference to FIG. 2, according to some non-limiting embodiments or aspects, the payment gateway systems 206b-206n may each include a credit data database 214b-214n for storing credits earned by the payment gateway systems 206b-206n as a result of sharing hashed payment data with the private data system 208 (as described hereinafter).

With continued reference to FIG. 2, according to some non-limiting embodiments or aspects, the private data system 208 may include a hashed payment data database 216. The hashed payment data database 216 may store the hashed payment data received by the private data system 208 from the payment gateway systems 206b-206n through shared data messages as part of the sharing protocol. The private data system 208 may include a request server 218 configured to receive a query from the payment gateway system 206a as part of the query protocol. The private data system 208 may include a query engine 220 configured to communicate with the hashed payment data database 216 and the request server 218 as part of the query protocol to search the hashed payment data database 216 and generate the query response message.

The request server 218 and/or the query engine 220 may communicate with a counter 222, which may count a number or amount of hashed payment data received from the payment gateway systems 206b-206n and/or used by the private data system 208 in generating the query response message. The counter 222 may communicate with a credit generator 224 to generate credits for the various payment gateway systems 206b-206n based on the number or amount of hashed payment data received from the payment gateway systems 206b-206n and/or used by the private data system 208 in generating the query response message. The various payment gateway systems 206b-206n may receive credits for providing hashed payment data and/or for the provided hashed payment data being used in query response messages, as described hereinafter. The credit generator 224 may communicate with the credit data databases 214b-214n of the various payment gateway systems 206b-206n to provide the earned credits to the various payment gateway systems 206b-206n.

Referring to FIGS. 1-3, according to some non-limiting embodiments or aspects, the systems for distributing data from multiple data sources may execute a sharing protocol. Referring to FIG. 2, at a step 1, the sharing protocol may include the second payment gateway system 206b communicating payment data (e.g., unhashed payment data) from the payment data database 210b to the hash system 212b. The payment data from the payment data database 210b may be hashed by the hash system 212b. For each payment datum communicated from the payment data database 210b to the hash system 212b, the hash system 212b may generate a plurality of hashed data by hashing the payment datum using a plurality of hash algorithms. For example, for a payment datum, the hash system may apply the hash algorithm 1 to derive a first hash value, the hash algorithm 2 to derive a second hash value, and so on, such that the first hash value, the second hash value, and any other hash value derived from the payment datum correspond to the payment datum. In some non-limiting embodiments or aspects, the payment data being hashed may include an account identifier, such as a PAN.

At a step 2, the sharing protocol may include the hash system 212b communicating the hashed payment data (including the first hash value, the second hash value, etc.) to the hashed payment database 216 of the private data system 208 via a shared data message for storage therein. In some non-limiting embodiments or aspects, the shared data message may also include the unhashed data, or the unhashed data may not be communicated to the private data system 208 based on privacy laws, privacy concerns, and the like. The shared data message may be communicated by the hash system 212b in response to the second payment gateway system 206b receiving a transaction request message from merchant system in order to communicate the payment data associated therewith (after hashing) with the private data system 208. The hash system 212b may communicate hashed data associated with a single transaction request message or with a plurality of transaction request messages (e.g., in a batch process).

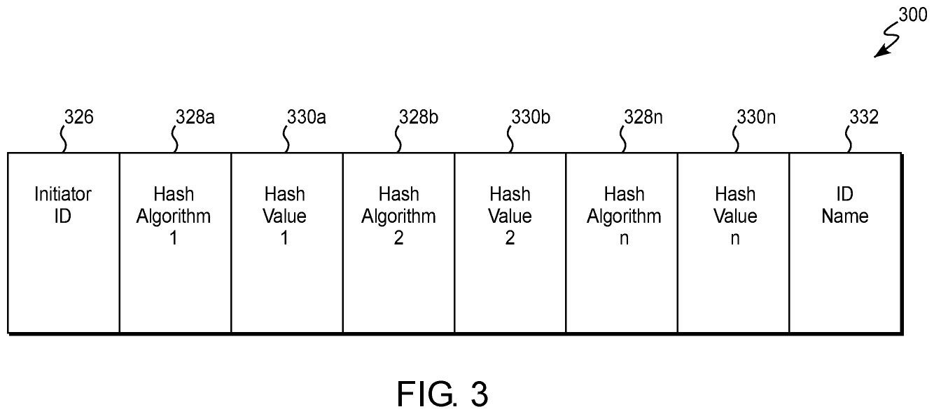

Referring to FIG. 3, a data structure 300 of a shared data message is shown according to some non-limiting embodiments or aspects. The data structure 300 may include an initiator ID 326, which may include a unique identifier identifying the payment gateway system from which the shared data message is being received (e.g., payment gateway system 206b-206n from FIG. 2). The data structure 300 may include an ID Name 332, which may identify the type of payment data being included in the shared data message. The shared data message may include a single type of payment data or a plurality of types of payment data.

The data structure may include a plurality of hash algorithm identifiers 328a-328n and a corresponding plurality of hash values 330a-330n, all derived from a single unhashed payment datum. The hash algorithm identifiers 328a-328n may identify the hash algorithm used to derive the corresponding hash values 330a-330n.

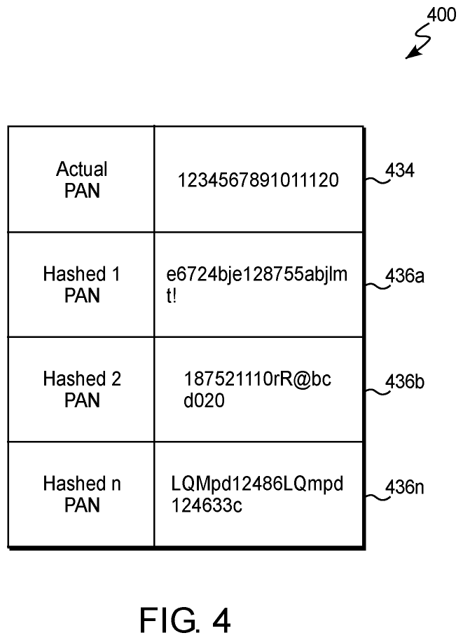

Referring to FIGS. 3 and 4, in one non-limiting example of the data structure 300 of the shared data message, the ID name 332 may be an account identifier (e.g., user PAN). FIG. 4 shows a table 400 having an actual user account identifier 434 and a first, second, and nth hashed value 436a-436n associated with that same account identifier. In the data structure 300 from FIG. 3, the first hash value 330a may include the first hashed value 436a from the table 400, and the first hash algorithm 328a may identify the hash algorithm used to generate the first hashed value 436a. In the data structure 300 from FIG. 3, the second hash value 330b may include the second hashed value 436b from the table 400, and the second hash algorithm 328b may identify the hash algorithm used to generate the second hashed value 436b. In the data structure 300 from FIG. 3, the nth hash value 330n may include the nth hashed value 436n from the table 400, and the nth hash algorithm 328n may identify the hash algorithm used to generate the nth hashed value 436n. The non-limiting example of the data structure described in connection with FIGS. 3 and 4 includes a single ID name 332 (account identifier); however, it will be appreciated that the shared data message may include hashed payment data for a plurality of types of payment data in a single data message.

Referring again to FIG. 2, at a step 3, the query protocol may include the first payment gateway system 206a communicating a query to the query server 218 of the private data system 208.

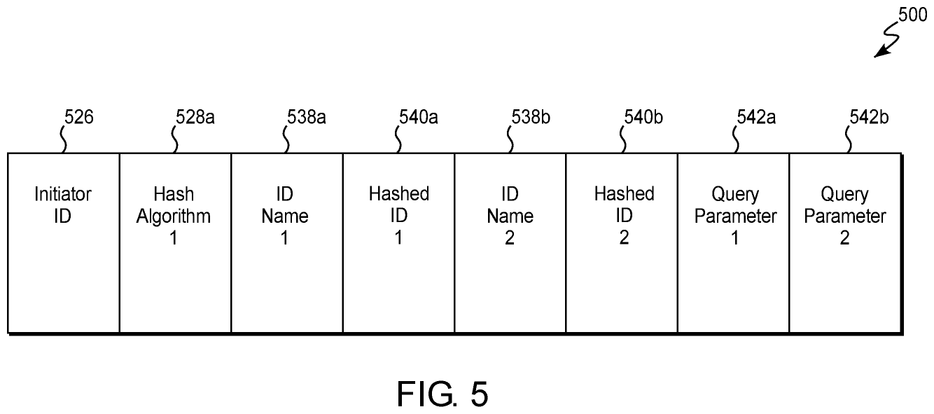

Referring to FIG. 5, a data structure 500 of a query is shown according to some non-limiting embodiments or aspects. The data structure 500 of the query may include an initiator ID 526 (associated with an initiator account with the private data system 208), which may include a unique identifier identifying the payment gateway system from which the query is being received (e.g., first payment gateway system 206a from FIG. 2). The data structure 500 of the query may include a first hash algorithm identifying the hash algorithm used to generate the hashed data (hashed ID 1 540a and hashed ID 2 540b) contained in the data structure 500. The data structure 500 may contain hashed data derived using a single hash algorithm or using a plurality of hash algorithms. The data structure 500 of the query may include at least one ID name 538a, 538b, which may identify the payment data type of the hashed ID 1 540a and hashed ID 2 540b, respectively. The data structure 500 of the query may include a hashed ID 540a, 540b corresponding to each ID name 538a, 538b included in the data structure 500. The hashed ID 540a, 540b may include hashed payment data corresponding to the payment data type identified by each ID name 538a, 538b. As one non-limiting example, ID name 1 538a may indicate that the payment data type is account identifier, and ID name 2 538b may indicate that the payment data type is expiration date of the payment device. Thus, hashed ID 1 540a may include the hashed value associated with the account identifier, and hashed ID 2 540b may include the hashed value associated with the expiration date of the payment device. The hash algorithm 1 528a may indicate that SHA-256 was the hash algorithm used to generate the hash ID 1 540a and hash ID 2 540b.

With continued reference to FIG. 5, the data structure 500 of the query may include at least one query parameter 542a, 542b. The query parameter may correspond to the value(s) which the query is requesting be returned by the private data system 208 in the query response message. The query parameter may include any data which may be derivable from the hashed payment data stored in the hashed payment database 216. For example, the query parameter may include a risk score, which may be determined based on the hashed payment data and returned via the query response message, such that the risk score comprehensively represents the risk associated with an electronic payment transaction based on payment data from a plurality of payment systems. The query parameter may include other data which may indicate whether an electronically payment transaction is potentially fraudulent, should be authorized, should be authenticated, and the like. As non-limiting examples, the query parameter may request the number of transactions initiated by a user over a period of time, an amount associated with transactions initiated by the user over a period of time, a number of transactions associated with the user that have been declined over a period of time, a location of the user's last transaction, and the like. The data structure 500 may include any number of query parameters, depending on the data being requested by the first payment gateway system 206a.

Referring again to FIG. 2, at a step 4, the query protocol may include, in response to receiving the query, the request server 218 communicating the query to the query engine 220 to cause the query engine to generate a query response message. At a step 5, the query protocol may include the query engine 220, based on the received query, searching the hashed payment data stored in the hashed payment data database 216. The search may be performed based on matching the at least one hash value from the query with at least one hashed payment data record from the hashed payment data database 216. Based on the match, the query engine 220 may analyze the relevant stored hashed payment data records to determine a return value(s) associated with the query parameter(s). The return value may constitute the “answer” associated with the query parameter (the “question”). For example, for a query parameter being the number of transactions initiated by a user over the last 24 hours, the return value may be the specific number of transactions initiated by that user within the last 24 hours. This return value may be based on hashed payment data received by the hashed payment data database 216 from the second payment gateway system 206b (and any other payment gateway system). As such, the first payment gateway system 206a may benefit in its analysis by receiving the return value because the return value includes data not otherwise available to the first payment gateway system 206a. This allows for the first payment gateway system 206a to make a more informed and/or accurate and/or efficient determination based on the return value.

With continued reference to FIG. 2, the query protocol may include the query engine 220 generating the query response message based on its search of the hashed payment data database 216. The private data system 208 (e.g., the query engine 220 and/or the request server 218) may communicate the query response message to the first payment gateway system 206a as part of the query protocol.

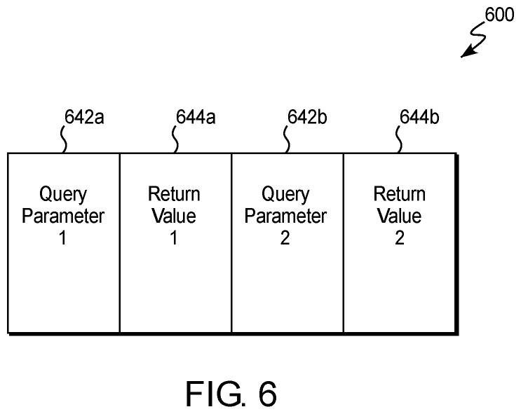

Referring to FIG. 6, a data structure 600 of a query response message is shown according to some non-limiting embodiments or aspects. Query parameter 1 642a and query parameter 2 642b may correspond to the query parameters 542a, 542b, respectively, from the data structure 500 of the query shown in FIG. 5. Return value 1 644a and return value 2 644b correspond to query parameter 1 642a and query parameter 2 642b and constitute the above-described return values (answers) associated with the corresponding query parameters.

Referring again to FIG. 2, according to some non-limiting embodiments or aspects, the private data system 208 may associate at least one credit with at least one of the payment gateway systems 206b-206n communicating hashed payment data to the hashed payment data database 216. The credits may enable a payment gateway system to query the private data system 208. For example, the private data system 208 may charge the first payment gateway system 206a at least one credit to submit a query to the payment gateway system (and receive a query response message therefrom).

Payment gateway systems may receive (e.g., earn) at least one credit from the private data system 208. In some non-limiting embodiments or aspects, the payment gateway system may receive at least one credit based on the hashed payment data it sent to the private data system 208 in a shared data message and/or that data being used in generating a query response message for it or another payment gateway system. The payment gateway system may receive the credit (the private data system may 208 associate a credit therewith) based on the private data system 208 communicating the query response message to the other payment gateway system, that query response message based on the hashed payment data provided by the payment gateway system. The payment gateway system may receive the credit in response to the private data system 208 identifying a hashed data record provided therefrom in the hashed payment data database 216, the private data system 208 generating the query response message based at least partially on the hashed payment data provided therefrom, and/or the private data system 208 communicating the query response message based at least partially on the hashed payment data provided therefrom.

In some non-limiting embodiments or aspects, the payment gateway system may receive at least one credit in response to the payment gateway system communicating the shared data message to the private data system 208. The private data system 208 may communicate the credit in response to the hashed payment data received from the payment gateway system being stored in the hashed payment data database 216.

Referring again to FIG. 2, at a step 6, in response to receiving the query, the request server 218 may communicate with the counter 222 to determine a number of credits associated with the first payment gateway system 206a. This determination may be made based on the initiator ID 326 (see FIG. 3) from the query. The counter 222 may determine how many credits the first payment gateway system 206a has in response to receiving the initiator ID 326 associated with the first payment gateway system. The counter 222 may store a count of how many queries the first payment gateway system 206a has submitted and/or how many shared data messages the first payment gateway system 206a has submitted and/or how many times hashed payment data from those shared data messages has been used in query response message to other payment gateway systems to determine the number of credits associated with the first payment gateway system 206a. In response to the counter 222 determining that the first payment gateway system 206a includes sufficient credits, the counter 222 may communicate to the request server 218 and/or the query engine 220 to cause the query to be processed and the query response message to be generated and transmitted. In response to the counter 222 determining that the first payment gateway system 206a includes insufficient credits, the counter 222 may communicate to the request server 218 and/or the query engine 220 to terminate processing of the query. The request server 218 may communicate a query termination message to the first payment gateway system 206a to indicate that the first payment gateway system 206a has insufficient credits to run the query.

With continued reference to FIG. 2, at a step 7, based on at least one of receiving a shared data message from the second payment gateway system 206b and generating and/or transmitting a query response message to the first payment gateway system 206a based on hashed payment data received from the second payment gateway system 206b, the query engine 220 may communicate with the counter 222. This communication may cause the counter 222 to determine a number of credits to be associated with the second payment gateway system 206b based on the action thereby (of sending the shared data message or its hashed payment data being used by the private data system 208). In response to the counter 222 determining the number of credits to be associated with the second payment gateway system 206b, at a step 8, the counter 222 may communicate with the credit generator 224 to cause the credit generator 224 to generate the associated number of credits. The generated credits may be stored associated with the second payment gateway system 206b in the private data system 208, such as at the credit generator 224 and/or at the counter 222 and/or some other database thereof. At a step 9, the credit generator 224 may communicate the generated credits to the second payment gateway system 206b to cause the second payment gateway system 206b to store the credits in the credit data database 214b. The credit data database 214b may be updated to store additional credits in response to the credit generator 224 communicating that the second payment gateway system 206b earned credits, and the credit data database 214b may be updated to remove stored credits in response to the second payment gateway system 206b receiving a query response message from a query submitted by the second payment gateway system 206b. The query response message may indicate the number of credits charged to the second payment gateway system 206b to cause the credit data database 214b to be updated and/or the private data system 208 (e.g., the credit generator 224 and/or the counter 222) may communicate a separate message to the credit data database 214 to cause the credit data database 214b to be updated.

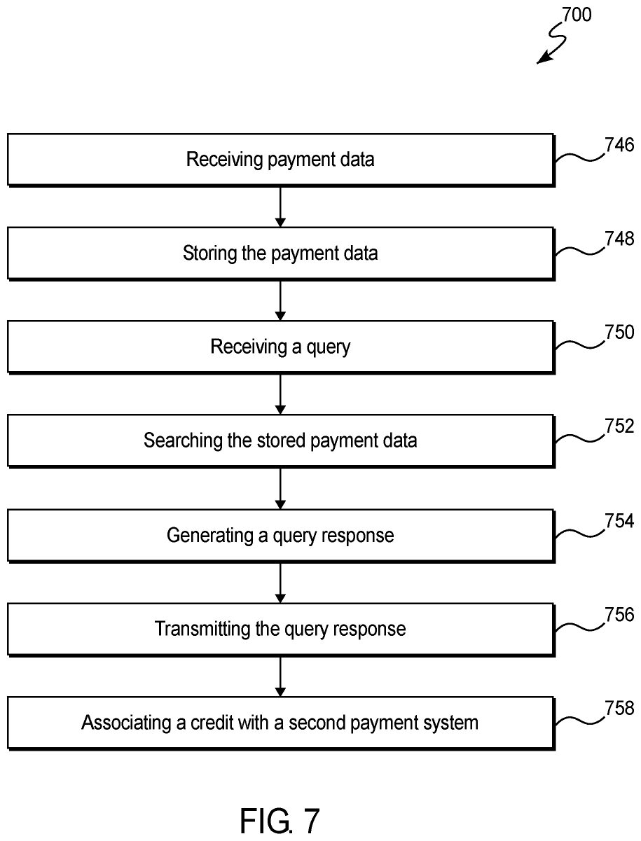

Referring to FIG. 7, a method 700 is shown for distributing data from multiple data sources according to some non-limiting embodiments or aspects. At a step 746, the private data system may receive, from a plurality of payment systems (e.g., payment gateway systems), payment data associated with a plurality of users and a plurality of transactions. At a step 748, the private data system may store the payment data in the hashed payment data database. At a step 750, the private data system may receive a query comprising at least one query parameter and at least one hash value derived from payment data for a user of the plurality of users from a first payment system. At a step 752, the private data system may search the payment data stored in the hashed payment data database based on the at least one hash value and the at least one query parameter to identify at least one data record from the payment data stored in the hashed payment data database that matches the query. The at least one data record was received from a second payment system of the plurality of payment systems.

With continued reference to FIG. 7, at a step 754, the private data system may generate a query response message based on the at least one data record and the at least one query parameter. At a step 756, the private data system may transmit the query response message to the first payment system. At a step 758, the private data system may associate at least one credit with the second payment system based on transmitting the query response message.

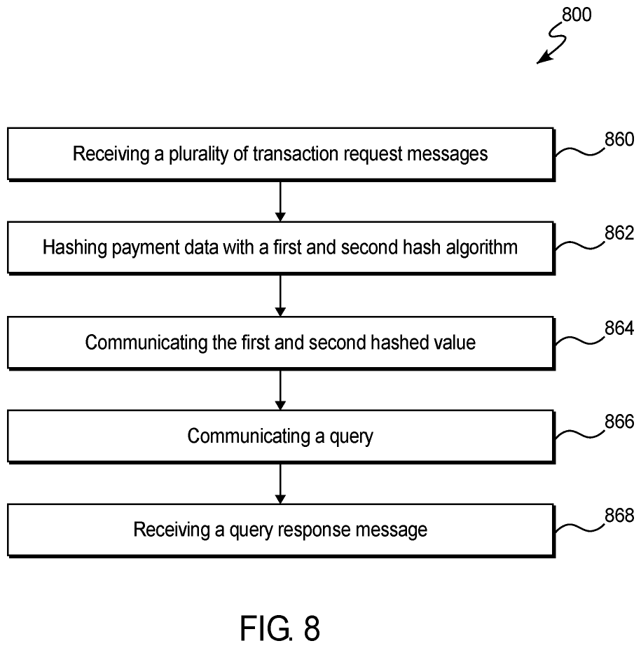

Referring to FIG. 8, a method 800 is shown for distributing data from multiple data sources according to some non-limiting embodiments or aspects. At a step 860, a first payment system may receive, from a plurality of merchant systems, a plurality of transaction request messages comprising payment data associated with a plurality of users and a plurality of transactions At a step 862, the first payment system may, for each transaction request message, hash at least a portion of the payment data associated with the transaction request message with a first hash algorithm to generate a first hashed value and hash the at least a portion of the payment data associated with the transaction request message with a second hash algorithm to generate a second hashed value.

With continued reference to FIG. 8, at a step 864, the first payment system may communicate the first hashed value and the second hashed value to a central server (e.g., private data system) to cause the central server to store the first hashed value and the second hashed value in association with a user of the plurality of users associated with the transaction request message in the hashed payment data database. At a step 866, the first payment system may communicate a query to the central server, the query comprising at least one query parameter and at least one hash value derived from payment data for a user of the plurality of users. At a step 868, the first payment system may receive from the central server a query response message based on payment data stored in the hashed payment data database that matches the query. The payment data stored in hashed payment data database that matches the query may have been received by the central server from a second payment system different from the first payment system.

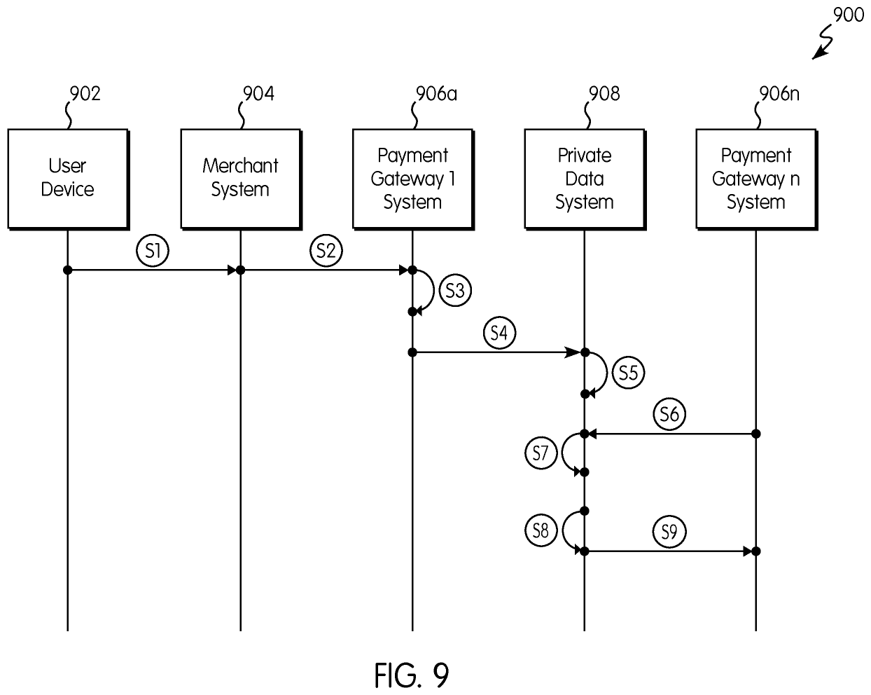

Referring to FIG. 9, a method 900 is shown for distributing data from multiple data sources according to some non-limiting embodiments or aspects. At a step S1, the user device 902 may initiate an electronic payment transaction with the merchant system 904. At a step S2, the merchant system 904 may communicate the transaction request message to the first payment gateway system 906a to cause the first payment gateway system 906a to process the electronic payment transaction to completion (e.g., authorization, clearing, settlement. The first payment gateway system 906a may communicate with the electronic payment processing network to process the electronic payment transaction to completion.

With continued reference to FIG. 9, at a step S3, the first payment gateway system 906a may store the payment data associated with the transaction request message in the payment data database. At a step S4, the first payment gateway system 906a may communicate the shared data message to the private data system. This may include the first payment gateway system 906a hashing the payment data to generate hashed payment data, the hashed payment data including a plurality of hashed data derived from the same original payment data but hashed using a plurality of different hash algorithms (e.g., the first hashed value and the second hashed value). The hashed payment data may be communicated to the private data system 908 in the shared data message. At a step S5, the private data system 908 may store the received hashed payment data in the hashed payment data database.

With continued reference to FIG. 9, at a step S6, the nth payment gateway system 906n may submit the query to the private data system 908. The query may include at least one hash value (derived from a hash algorithm) and at least one query parameter. In response to receiving the query, at a step S7, the private data system 908 may search the hashed payment data database based on the at least one hash value and the at least one query parameter to identify at least one data record from the hashed payment data stored in the hashed payment data database that matches the query. The at least one data record may have been received from the first payment gateway system 906a. At a step S8, the private data system 208 may generate the query response message based on the at least one data record and the at least one query parameter. At a step S9, the private data system may transmit the query response message to the nth payment gateway system 906n.

In some non-limiting embodiments or aspects, a computer program product for distributing data from multiple data sources includes at least one non-transitory computer readable medium including program instructions that, when executed by at least one processor, cause the at least one processor to execute one of the previously-described methods. The at least one processor may include the private data system and/or any of the payment systems (e.g., payment gateway systems) described herein.

Although the disclosure has been described in detail for the purpose of illustration based on what is currently considered to be the most practical and preferred embodiments, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

The invention claimed is:

1. A method for distributing data from multiple data sources, comprising:
receiving, from a plurality of payment systems, payment data associated with a plurality of users and a plurality of transactions;
storing, with at least one processor, the payment data in at least one data storage device;
receiving, from a first payment system, a query comprising at least one query parameter and at least one hash value derived from payment data for a user of the plurality of users;
searching, with at least one processor, the payment data stored in the at least one data storage device based on the at least one hash value and the at least one query parameter to identify at least one data record from the payment data stored in the at least one data storage device that matches the query, wherein the at least one data record was received from a second payment system of the plurality of payment systems;
generating, with at least one processor, a query response message based on the at least one data record and the at least one query parameter;
transmitting, with at least one processor, the query response message to the first payment system; and
associating, with at least one processor, at least one credit with the second payment system based on transmitting the query response message.

2. The method of claim 1, wherein the payment data comprises: (i) a plurality of account identifiers associated with the plurality of users and/or (ii) a plurality of hash values derived from the plurality of account identifiers.

3. The method of claim 1, wherein the query comprises an account identifier, a hash value derived from the account identifier, and/or a hash algorithm identifier.

4. The method of claim 1, wherein the payment data comprises a plurality of hash values derived from a single account identifier, each of the plurality of hash values derived from a different hashing algorithm.

5. The method of claim 1, wherein the at least one credit is associated with the second payment system in response to identifying the at least one data record, generating the query response message, or transmitting the query response message.

6. The method of claim 1, wherein the query comprises a payment system identifier associated with the first payment system, wherein the method further comprises:
determining, with at least one processor, whether the first payment system comprises at least one credit; and
in response to determining that the first payment system comprises at least one credit, searching the payment data stored in the at least one data storage device based on the at least one hash value and the at least one query parameter to identify the at least one data record from the payment data stored in the at least one data storage device that matches the query.

7. A system for distributing data from multiple data sources, comprising:
at least one storage device; and
at least one processor programmed or configured to:
receive, from a plurality of payment systems, payment data associated with a plurality of users and a plurality of transactions;
store the payment data in the at least one data storage device;
receive a query comprising at least one query parameter and at least one hash value derived from payment data for a user of the plurality of users;
search the payment data stored in the at least one data storage device based on the at least one hash value and the at least one query parameter to identify at least one data record from the payment data stored in the at least one data storage device that matches the query, wherein the at least one data record was received from a second payment system of the plurality of payment systems;
generate a query response message based on the at least one data record and the at least one query parameter;
transmit the query response message to the first payment system; and
associate at least one credit with the second payment system based on transmitting the query response message.

8. The system of claim 7, wherein the payment data comprises: (i) a plurality of account identifiers associated with the plurality of users and/or (ii) a plurality of hash values derived from the plurality of account identifiers.

9. The system of claim 7, wherein the query comprises an account identifier, a hash value derived from the account identifier, and/or a hash algorithm identifier.

10. The system of claim 7, wherein the payment data comprises a plurality of hash values derived from a single account identifier, each of the plurality of hash values derived from a different hashing algorithm.

11. The system of claim 7, wherein the at least one credit is associated with the second payment system in response to identifying the at least one data record, generating the query response message, or transmitting the query response message.

12. The system of claim 7, wherein the query comprises a payment system identifier associated with the first payment system, wherein the at least one processor is further programmed or configured to:
determine whether the first payment system comprises at least one credit; and
in response to determining that the first payment system comprises at least one credit, search the payment data stored in the at least one data storage device based on the at least one hash value and the at least one query parameter to identify the at least one data record from the payment data stored in the at least one data storage device that matches the query.

13. A method for distributing data from multiple data sources, comprising:
receiving, from a plurality of merchant systems, a plurality of transaction request messages comprising payment data associated with a plurality of users and a plurality of transactions;
for each transaction request message, hashing, with at least one processor, at least a portion of the payment data associated with the transaction request message with a first hash algorithm to generate a first hashed value and hashing, with at least one processor, the at least a portion of the payment data associated with the transaction request message with a second hash algorithm to generate a second hashed value;
communicating, from a first payment system of a plurality of payment systems, the first hashed value and the second hashed value to a central server to cause the central server to store the first hashed value and the second hashed value in association with a user of the plurality of users associated with the transaction request message in at least one data storage device;
communicating, from the first payment system and to the central server, a query comprising at least one query parameter and at least one hash value derived from payment data for a user of the plurality of users; and
receiving, by the first payment system and from the central server, a query response message based on payment data stored in the at least one data storage device that matches the query, wherein the payment data stored in the at least one data storage device that matches the query was received by the central server from a second payment system of the plurality of payment systems.

14. The method of claim 13, wherein the query causes the central server to:
search the payment data stored in the at least one data storage device based on the at least one hash value and the at least one query parameter to identify at least one data record from the payment data stored in the at least one data storage device that matches the query, wherein the at least one data record was received from a second payment system of the plurality of payment systems;
generate the query response message based on the at least one data record and the at least one query parameter; and
transmit the query response message to the first payment system; and
associate at least one credit with the second payment system based on transmitting the query response message.

15. The method of claim 13, wherein the payment data comprises: (i) a plurality of account identifiers associated with the plurality of users and/or (ii) a plurality of hash values derived from the plurality of account identifiers.

16. The method of claim 13, wherein the query comprises an account identifier, a hash value derived from the account identifier, and/or a hash algorithm identifier.

17. The method of claim 13, wherein the query comprises a payment system identifier associated with the first payment system, wherein the query causes the central server to:
determine whether the first payment system comprises at least one credit; and
in response to determining that the first payment system comprises at least one credit, search the payment data stored in the at least one data storage device based on the at least one hash value and the at least one query parameter to identify the at least one data record from the payment data stored in the at least one data storage device that matches the query.

18. The method of claim 13, further comprising:
receiving, by the first payment system and from the central server, at least one credit in response to communicating the first hashed value and the second hashed value to the central server.
